(19) United States
(12) Patent Application Publication
(10) Pub. No.: US 2014/0248928 A1
(43) Pub. Date: Sep. 4, 2014

(54) WIRELESS TERMINAL AND INFORMATION PROCESSING METHOD THEREOF

(71) Applicant: INFOBANK CORP., Seongnam-si, Gyeonggi-do (KR)

(72) Inventors: Byung hyun Ryu, Seoul (KR); Jun ho Jang, Seongnam-si (KR)

(73) Assignee: INFOBANK CORP., Seongnam-si, Gyeonggi-do (KR)

(21) Appl. No.: 14/352,417

(22) PCT Filed: Oct. 17, 2012
(86) PCT No.: PCT/KR2012/008473

§ 371 Date: Apr. 17, 2014

(30) Foreign Application Priority Data
Oct. 17, 2011 (KR) 10-2011-0106074

(51) Int. Cl. G06F 3/01; H04M 1/725

(52) U.S. Cl. CPC G06F 3/017; H04M 1/72538
USPC 455/566

(57) ABSTRACT

The present invention is related to a wireless terminal, an information processing method thereof, and a computer-readable recording medium. The wireless terminal of the present invention includes an output section for outputting a contents selection screen for selecting contents to be transmitted in voice communication and a motion pattern setting screen for informing transmission starting of the contents; a storage section for connecting the contents information and the motion pattern information selected and set through the contents selection screen and the motion pattern setting screen outputted by the output section and storing them into the memory; a motion pattern check section for checking pattern information of motions sensed from at least one sensor disposed in the wireless terminal; a check section firstly checking whether the motion pattern information corresponding to the motion pattern information checked through the motion pattern check section in the voice communication is pre-stored into the memory and secondly checking contents information connected to the motion pattern information pre-stored into the memory; and a processing section for transmitting the contents corresponding to the contents information checked through the check section to the other party's terminal.

### BACKGROUND OF THE INVENTION

1. Technical Field

The present invention provides convenience for contents transmission processes while minimizing voice communication delay due to contents transmission on transmitting contents to a receiving terminal in voice communication.

2. Description of the Related Art

In recent, activity for building RCS (Rich Communication Suite) technologies that implement next generation mobile communication service and interwork services between mobile carriers has become active. Therefore, technologies that receive amusing multimedia pictures or photos from the other party in the voice communication and talk stories while together watching them are becoming true. Further, a system and method for transmitting files in the voice communication are disclosed in Korean Patent Application Number: 10-2006-0010071 (Title: file transmission system and method thereof in the voice communication).

However, real time transmission of the contents or files in the voice communication causes the voice communication delay and inconvenience due to adding of the processes for selecting the contents or files that want to transmit in the voice communication from a sending wireless terminal, and solution about it is needed.

### SUMMARY OF THE INVENTION

An advantage of some aspects of the invention is that it provides a wireless terminal capable of transmitting contents to the other party's terminal in voice communication by simple motions only from a sending wireless terminal and solving voice communication delay and inconvenience due to the selection of the contents or files to be transmitted in the voice communication by previously selecting the contents to be transmitted in the voice communication prior to the connection of the voice communication with a receiving wireless terminal and setting commands for transmitting the corresponding contents in the voice communication into simple motion patterns(shaking, etc.), an information processing method thereof, and a computer-readable recording medium for recording programs to execute information processing.

According to an aspect of the invention, there is provided a wireless terminal including an output section for outputting a contents selection screen for selecting the contents to be transmitted in voice communication and a motion pattern setting screen for informing transmission starting of the contents; a storage section for connecting contents information and motion pattern information selected and set through the contents selection screen and the motion pattern setting screen outputted by the output section and storing them into a memory; a motion pattern check section for checking pattern information of motions sensed from at least one sensor disposed in the wireless terminal; a check section for firstly checking whether the motion pattern information corresponding to the motion pattern information checked through the motion pattern check section in the voice communication is pre-stored into the memory and secondly checking the contents information connected to the motion pattern information pre-stored into the memory; and a processing section for transmitting the contents corresponding to the contents information checked through the check section to the other party' terminal.

According to another aspect of the invention, there is provided a wireless terminal including an output section for outputting a contents selection screen for selecting the contents to be transmitted in voice communication; a storage section for storing the contents information selected through the contents selection screen outputted by the output section as the contents information to be transmitted in the voice communication into a memory; a motion pattern check section for checking pattern information of motions sensed from at least one sensor disposed in the wireless terminal; a check section for firstly checking whether the motion pattern information checked through the motion pattern check section is corresponded to the motion pattern information pre-set by contents transmission commands in the voice communication, and then for secondly checking the contents information to be transmitted, in the voice communication, pre-stored into the memory; and a processing section for transmitting the contents corresponding to the contents information checked through the check section to the other party's terminal.

It is preferable that the contents selection screen and motion pattern setting screen at the wireless terminal are configured with a single screen or at least two screens.

It is preferable that the output section additively outputs screens for selecting or inputting output sensitivity or intensity information of the contents on outputting the contents selection screen for selecting the contents to be transmitted in the voice communication, and the screens for selecting or inputting the output sensitivity or intensity information of the contents are outputted on the same screen as the contents selection screen or through a separable screen.

It is preferable that the contents is simultaneously driven at the wireless terminal and the other party' terminal by the processing section on transmitting the contents to the other party's terminal.

According to an aspect of the invention, there is provided an information processing method for a wireless terminal including outputting a contents selection screen for selecting the contents to be transmitted in voice communication and a motion pattern setting screen for informing transmission starting of the contents; connecting contents information and motion pattern information selected and set through the outputted contents selection screen and the motion pattern setting screen and storing them into the memory; checking pattern information of motions sensed from at least one sensor disposed in the wireless terminal; firstly checking whether the motion pattern information corresponding to the checked motion pattern information in the voice communication is pre-stored into the memory and secondly checking the contents information connected to the motion pattern information pre-stored into the memory; and for transmitting the contents corresponding to the checked contents information to the other party's terminal.

According to another aspect of the invention, there is provided an information processing method for a wireless terminal including storing contents information to be transmitted in voice communication into a memory; checking pattern information of motions sensed from at least one sensor disposed in the wireless terminal; checking whether the checked motion pattern information is corresponded to the motion pattern information pre-set by contents transmission commands in the voice communication; checking the contents information to be transmitted, in voice communication, pre-stored into the memory when the checked motion pattern information is the motion pattern information pre-set by contents transmission commands in the voice communication; and transmitting the contents corresponding to the checked contents information to the other party's terminal.

It is preferable that the information processing method for the wireless terminal may implement each step by programs, and the present invention includes a computer-readable recording medium for recording the programs.

In the present invention, the motion pattern information includes at least one of times or pattern information that the allows the wireless terminal to shake horizontally or vertically or back and forth, pattern information drawing shapes of figures including at least one of triangle, square, circle, ellipse, and touch pattern information inputted on a touch pad, and the sensor includes at least one of a gyro sensor, a gravity sensor, a geomagnetic sensor and a touch sensor.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 shows configurations of the entire system according to an embodiment of the present invention.

FIG. 2 shows sub-configurations for a sending wireless terminal according to the embodiment of the present invention.

FIG. 3 shows a contents setting process to be transmitted in voice communication according to the embodiment of the present invention.

FIG. 4 shows the contents setting process performed by motion patterns in the voice communication according to the embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the sprit of the present invention should not be limited to the above-described embodiments, and the following claims as well as all modified equally or equivalently to the claims are intended to fall within the scope and spirit of the invention.

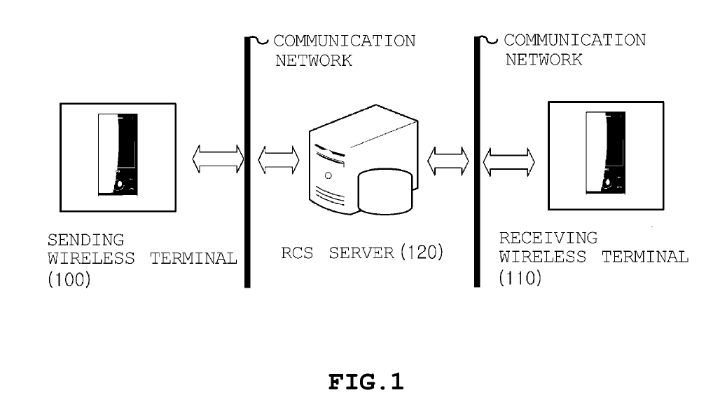

FIG. 1 shows configurations of the entire system according to an embodiment of the present invention.

In more detail, FIG. 1 shows that a sending wireless terminal 100 and receiving wireless terminal 110 are connected to a RCS server 120 through communication networks and shows configurations for transmitting contents in response to motion patterns at the sending wireless terminal 100 in the voice communication between the sending wireless terminal 100 and receiving wireless terminal 110.

Although not separately shown in drawings, connections between the sending wireless terminal 100, the receiving wireless terminal 110, and the RCS server 120 may be variously configured by the intention of one skilled in the art.

The RCS server 120 of the present invention, which is a server for processing RCS (Rich Communication Suite) technologies for services between mobile carriers, serves to transmit contents in the voice communication between the sending wireless terminal 100 and the receiving wireless terminal 110.

Contents transmitting technologies in the voice communication performed by the RCS server 120 are not described in more detail because it is a prior art.

The sending wireless terminal 100 of the present invention serves to transmit the set contents to the receiving wireless terminal 110 by simple motions only in the voice communication with the receiving wireless terminal 110 by selecting the contents to be transmitted in the voice communication prior to the connection of the voice communication with the receiving wireless terminal 110, and setting commands for transmitting the corresponding contents in the voice communication into simple motion patterns (shaking, etc.).

That is, the sending wireless terminal 100 outputs a contents selection screen for selecting the contents to be transmitted in the voice communication and a motion pattern setting screen for informing transmission starting of the contents, connects contents information and motion pattern information selected and set by the outputted contents selection screen and motion pattern setting screen and stores the connected them into a memory 240, checks pattern information of motions sensed from at least one sensor in the voice communication with the receiving wireless terminal 110, firstly checks whether the motion pattern information corresponding to the checked motion pattern information is pre-stored into the memory 240 and secondly checks the contents information connected to the motion pattern information pre-stored into the memory 240, and transmits the contents corresponding to the checked contents information to the receiving wireless terminal 110, according to an embodiment of the present invention.

Further, the sending wireless terminal 100 outputs the contents selection screen only for selecting the contents to be transmitted in the voice communication, stores the contents information selected by the outputted contents selection screen as the contents information to be transmitted in the voice communication into the memory 240, checks pattern information of the motions sensed from at least one sensor in the voice communication with the receiving wireless terminal 110, firstly checks whether the checked motion pattern information is corresponded to the motion pattern information pre-set by the contents transmission commands in the voice communication and secondly checks the contents information to be transmitted, in the voice communication, pre-stored into the memory 240, and transmits the contents corresponding to the checked contents information to the receiving wireless terminal 110, according to another embodiment of the present invention, that is, in case that the motion pattern information corresponding to the commands for transmitting the contents in the voice communication is pre-set.

The sending wireless terminal 100 of the present invention may previously set the intensity or sensitivity of the contents transmitted into the receiving wireless terminal 110 in the voice communication, and the screen for setting the intensity or sensitivity of the contents is output by the same screen as the contents selection screen or is output by a separable screen.

Each function of the sending wireless terminal 100 of the present invention may be implemented by applications downloaded from servers on communication networks.

Wherein, the sending wireless terminal 100 includes all terminals, that is capable of performing mobile communication, such as a cellular phone, a smart phone, a tablet PC, etc.

The receiving wireless terminal 110 of the present invention serves to receive the contents to be transmitted, in the voice communication, from the sending wireless terminal 100, and includes all terminals, that is capable of performing the voice communication with the sending wireless terminal 100, such as the cellular phone, the smart phone, the tablet PC, a wire telephone, a home appliances, etc.

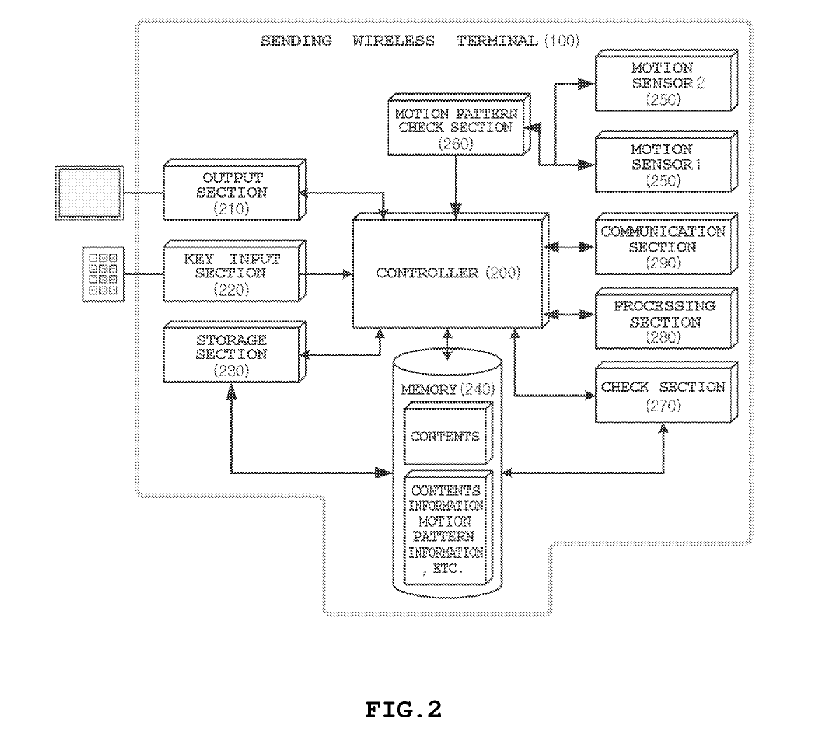

FIG. 2 shows sub-configurations of the sending wireless terminal 100 according to an embodiment of the present invention.

The wireless terminal 100 operated on a mobile communication system shown in FIG. 2 is used for processing information in the present invention and is not shown in more detail. However, the wireless terminal 100 includes an exterior body, a speaker, a microphone, a keypad, a LCD (Liquid Crystal Display), an antenna, a battery, etc. in hardware aspects, and includes all the functions and configurations of the wireless terminal 100 capable of communicating currently and in future.

Main configurations of the wireless terminal 100 according to the present invention referencing hardware features described above includes an output section 210, a key input section 220, a storage section 230, a memory section 240, at least one motion sensors, a motion pattern check section 260, a check section 270, a processing section 280, a communication section 290, and a controller for controlling each of the configurations, as shown in FIG.2, and each of the configurations may be added or excluded according to the kinds and features of the wireless terminal 100.

Referring to FIG. 2, the output section 210 outputs a contents selection screen for selecting the contents to be transmitted in the voice communication and a motion pattern setting screen for informing transmission starting of the contents.

That is, in the output section 210, a sender outputs an UI (User Interface) for selecting the contents to be transmitted in the voice communication previously prior to the voice communication with the receiving terminal 110 on the screen and may select the contents to be transmitted in the voice communication among the contents pre-stored into the wireless terminal 100.

Further, the output section 210 outputs a motion pattern setting screen for setting transmission time of the contents selected through the contents selection screen through the screen that is the same as the contents selection screen or the separable screen and therefore sets the motion patterns corresponding to transmission commands of the contents selected by the sender.

For example, when the sender wants to enjoy a moving picture A in the voice communication with the receiver, the sender selects the moving picture A through the contents selection screen prior to the voice communication with the receiver and sets the shaking in twice through the motion pattern setting screen.

Then, when the voice communication channels are connected between the sending wireless terminal 100 and the receiving wireless terminal 110 and the voice communication starts, after the sending wireless terminal 100 checks whether the pre-set twice shakings are sensed, it transmits the pre-selected moving picture A to the receiving wireless terminal 110 in case of sensing twice shakings.

Of course, in case of, further another embodiment of the present invention, that is, pre-setting the motion pattern information corresponding to commands for the contents transmission in the voice communication, the output section 210 may output the contents selection screen only for selecting the contents to be transmitted in the voice communication.

In addition, the output section 210 of the present invention may previously set the intensity or sensitivity of the contents transmitted into the receiving wireless terminal 110 in the voice communication, and the screen for setting the intensity or sensitivity of the contents is output by the same screen as the contents selection screen or is output by a separable screen.

The storage section 230 of the present invention connects the contents information and the motion pattern information selected and set through the contents selection screen and the motion pattern setting screen outputted by the output section 210 and therefore stores them into the memory 240.

Of course, in case of, further another embodiment of the present invention, that is, pre-setting the motion pattern information corresponding to commands for the contents transmission in the voice communication, the storage section 230 may store the contents information only selected through the contents selection screen into the memory 240.

The memory 240 of the present invention, which is a collective name of memory elements for storing a predetermined program routine (or code) and/or program data (for example, information and/or data inputted and outputted when operations executed by the program routine (or code) is performed) for controlling whole operations of the wireless terminal 100, includes ROM (Read Only memory) corresponding to read only memory, readable/writable Flash Memory(FM), and EEPROM(Electrically Erasable and Programmable Read Only Memory), etc.

The memory 240 of the present invention stores the contents information to be transmitted in the voice communication and the motion pattern information for informing transmission time of the contents, and may store the contents information only to be transmitted in the voice communication according to the embodiments of the present invention.

In addition, the memory 240 stores the contents to be transmitted, in the voice communication, except the contents information to be transmitted in the voice communication and the motion pattern information for informing transmission time of the contents, and may further store applications for performing roles for each configuration of the sending wireless terminal 100 according to the present invention.

A motion sensor 1 250 and a motion sensor 2 250—hereinafter, are called the motion sensor—according to the embodiment of the present invention, which is a sensor for sensing various motions of the sending wireless terminal 100, includes at least one of a gyro sensor, a gravity sensor, a geomagnetic sensor and a touch sensor, and may sense shaking, movement, and touch, etc. of the sending wireless terminal 100 by them.

Wherein, the motion sensor 1 250 and a motion sensor 2 250 are a separable sensor or may be one sensor, and the number of the sensor such as a motion sensor 3 may be increased.

A motion pattern check section 260 in the embodiment of the present invention checks the patterns of the motions sensed from the motion sensors 250.

That is, the motion pattern check section 260 checks the patterns of various motions sensed from the motion sensors 250, that is, times or patterns that the sending wireless terminal 100 shakes horizontally or vertically or back and forth, the patterns drawing shapes of standard figures including at least one of triangle, square, circle, ellipse, and patterns inputted on the touch pad.

In the checking section 270 of the present invention, the pattern information of the motions checked through the motion pattern check section 260 is pre-set and stored into the memory 240 by the contents transmission starting commands in the voice communication, or may determine the starting or not of the contents transmission, in the voice communication, according to the present invention as compared with politically pre-set motion pattern information.

For example, to check service starting, in the case that the pre-set motion pattern information is information that the wireless terminal 100 shakes twice horizontally, when the checking section 270 checks that the motion pattern check section 260 senses horizontal twice shaking of the sending wireless terminal 100 by the gyro sensor 250, it starts the contents transmission, in the voice communication, according to the present invention after comparing the checked motion pattern information with the predetermined motion pattern information.

Wherein, the motion pattern information includes at least one of times or pattern information that the sending wireless terminal 100 shakes horizontally or vertically or back and forth, pattern information drawing shapes of figures including at least one of triangle, square, circle, ellipse, and touch pattern information inputted on the touch pad.

Further, the check section 270 of the present invention secondly checks the contents information to be transmitted in the voice communication in correspondence with the motion pattern information through the memory 240 when contents transmission starting is determined in the voice communication.

The processing section 280 in the embodiment of the present invention processes so that the contents corresponding to the contents information checked through the check section 270 is transmitted into the receiving terminal 110.

That is, the processing section 280 extracts the contents to be transmitted, in the voice communication, corresponding to the contents information checked through the check section 270 pre-stored into the memory 240, and then the extracted contents is transmitted to the receiving terminal 110 through the communication section 290.

Further, when the contents to be transmitted in the voice communication is transmitted to the receiving terminal 110, the processing section 280 simultaneously drives the contents at the sending wireless terminal 100 and the receiving terminal 110.

For example, when the processing section 280 transmits a moving picture A to the receiving terminal 110 and then the moving picture A is completely downloaded into the receiving terminal 110, the moving picture A is automatically driven at the sending wireless terminal 100 and receiving terminal 110.

In addition, when the processing 280 transmits the moving picture A to the receiving terminal 100, the moving picture A is automatically driven at the sending wireless terminal 100 and receiving terminal 110 in a streaming process on transmitting the moving picture A by streaming technology.

Wherein, the streaming technology and automatic moving picture driving technology are prior arts and therefore the detailed description about them may be omitted.

The communication section 290 of the present invention processes the contents transmission from the sending wireless terminal 100 to the receiving terminal 110, and processes various communication such as transmission and receipt of information or data and the voice communication at the sending wireless terminal 100 except the contents transmission.

The controller 200 in the embodiment of the present invention controls functions of each configuration in the wireless terminal 100, and may be configured as programs or application types.

Further, all or some functions of the output section 210, the storage section 230, the motion pattern check section 260, the check section 270, and the processing section 280 except the controller 200 of the configurations of the wireless terminal 100 shown in FIG. 2 may be also implemented as a kind of the programs disposed in the wireless terminal 100, that is, the application types.

Hereinafter, processes for transmitting the contents from the sending wireless terminal 100 to the receiving terminal 110 in the voice communication by simple motions only by the functions and roles of each configuration of the sending wireless terminal 100 described above will be described in more detail.

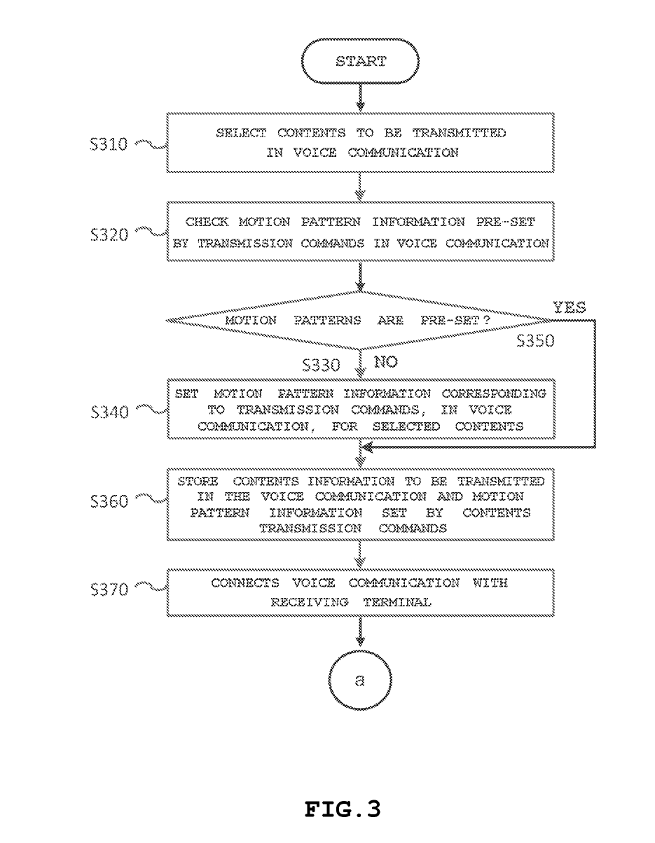

FIG. 3 shows a contents setting process to be transmitted in voice communication according to the embodiment of the present invention.

Firstly, the sending wireless terminal 100 outputs the contents selection screen for selecting the contents to be transmitted in the voice communication through the output section 210 on the screen, and selects the contents to be transmitted in the voice communication by the sender(S310).

Then, the sending wireless terminal 100 checks whether the motion pattern information pre-set as the contents transmission commands in the voice communication is politically included (S320), and sets (S340) the motion pattern information corresponding to the transmission commands, in the voice communication, for the contents selected at the step S310 in case of having no the pre-set motion pattern information (S330).

In the step that sets the motion pattern information corresponding to the transmission commands in the voice communication, the sending wireless terminal 100 outputs the motion pattern setting screen for informing the transmission starting of the contents to be transmitted, in the voice communication, through the output section 210, and selects or receives information for the motion patterns from the sender.

When the motion pattern information pre-set by the contents transmission commands in the voice communication is already included politically in the sending wireless terminal 100(S350), step S340 is omitted.

Although not separately shown in drawing, screen output and sender selection steps for setting the intensity or sensitivity of the contents to be transmitted in the voice communication may be further included in the steps S310 to S340.

Then, the sending wireless terminal 100 connects the contents information to be transmitted in the voice communication and the motion pattern information corresponding to the transmission commands for the contents and therefore stores them into the memory (S360).

The sending wireless terminal 100 connects the voice communication with the receiving terminal 110(S370).

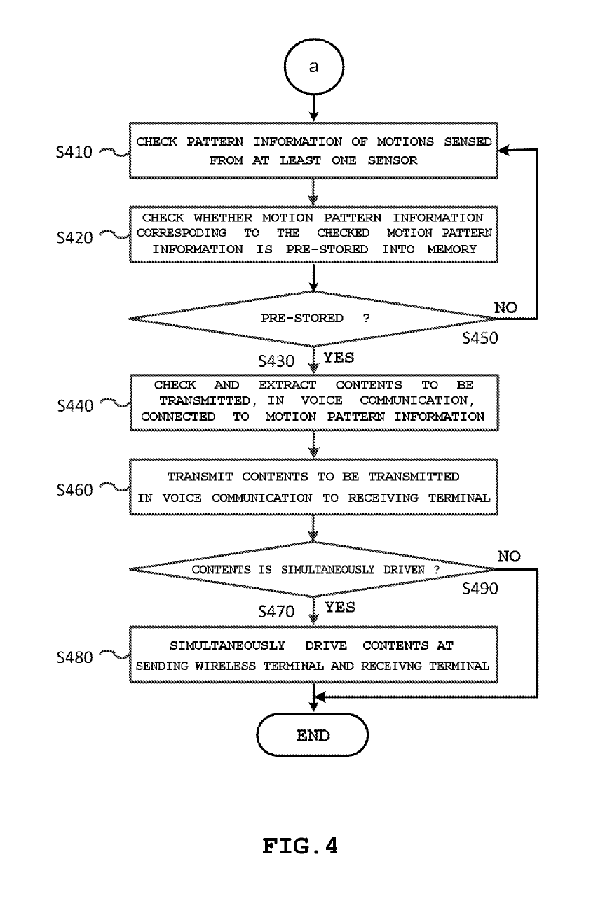

FIG. 4 shows a contents transmission process performed by motion patterns, in voice communication, according to the embodiment of the present invention.

After the voice communication between the sending wireless terminal 100 and the receiving terminal 110 is connected, the sending wireless terminal 100 senses its own shaking, movement, and touch, etc. by at least one sensor and checks the pattern information of the motions sensed through the motion pattern check section 260(S410).

The check section 270 of the sending wireless terminal 100 compares the motion pattern information checked through the motion pattern check section 260 with the motion pattern information pre-set and stored or politically pre-set by the contents transmission starting commands in the voice communication into the memory 240, and checks whether the motion pattern information to be matched is present (S420).

When the motion pattern information corresponding to the motion pattern information checked through the motion pattern check section 260 in step S420 is pre-stored or politically pre-set into the memory 240 (S430), the sending wireless terminal 100 checks and extracts the contents information connected to the motion pattern information through the check section 270 (S440).

When the motion pattern information corresponding to the motion pattern information checked through the motion pattern check section 260 in step 5420 is not stored into the memory 240 or is not pre-set politically, the sending wireless terminal 100 repeats the motion pattern information check step through the check section 260 (S450).

Then, the sending wireless terminal 100 transmits the contents extracted through the step S440 to the receiving terminal 110 connected to the voice communication.

When the contents is simultaneously driven at the sending wireless terminal 100 and the receiving terminal 110 (S470), the sending wireless terminal 100 simultaneously drives the contents at the sending wireless terminal 100 and the receiving terminal 110 through the processing section 280 (S480). When the contents is not simultaneously driven at the sending wireless terminal 100 and the receiving terminal 110, the processing is ended (S490)

According to an embodiment of the present invention, the present invention provides the convenience for transmitting the contents to the other party's terminal in the voice communication by simple motions only from the sending wireless terminal and solves the voice communication delay and inconvenience due to the selection of the contents or files to be transmitted in the voice communication, thereby to reduce voice communication fee loaded into a user.

1. A wireless terminal, comprising:
an output section for outputting a contents selection screen for selecting the contents to be transmitted in voice communication and a motion pattern setting screen for informing transmission starting of the contents;
a storage section for connecting the contents information and the motion pattern information selected and set through the contents selection screen and the motion pattern setting screen outputted by the output section and storing them into the memory;
a motion pattern check section for checking pattern information of motions sensed from at least one sensor disposed in the wireless terminal;
a check section for firstly checking whether the motion pattern information corresponding to the motion pattern information checked through the motion pattern check section in the voice communication is pre-stored into the memory and secondly checking the contents information connected to the motion pattern information pre-stored into the memory;
and a processing section for transmitting the contents corresponding to the contents information checked through the check section to the other party's terminal.

2. The wireless terminal according to claim 1,
wherein the check section for firstly checking checks whether the motion pattern information checked through the motion pattern check section is corresponded to the motion pattern information pre-set by contents transmission commands in the voice communication.

3. The wireless terminal according to claim 1, wherein the contents selection screen and motion pattern setting screen are configured with a single screen or at least two screens.

4. The wireless terminal according to claim 1, wherein the output section additively outputs screens for selecting or inputting output sensitivity or intensity information of the contents on outputting the contents selection screen for selecting the contents to be transmitted in the voice communication, and screens for selecting or inputting the output sensitivity or intensity information of the contents are outputted on the same screen as the contents selection screen or through a separable screen.

5. The wireless terminal according to claim 1, wherein the sensor includes at least one of a gyro sensor, a gravity sensor, a geomagnetic sensor and a touch sensor.

6. The wireless terminal according to claim 1, wherein the processing section simultaneously drives the contents at the wireless terminal and the other party's terminal on transmitting the contents to the other party's terminal.

7. The wireless terminal according to claim 1, wherein the motion pattern information includes at least one of times or pattern information that the wireless terminal shakes horizontally or vertically or back and forth, pattern information drawing shapes of figures including at least one of triangle, square, circle, ellipse, and touch pattern information inputted on the touch pad.

8. An information processing method for a wireless terminal, comprising:
outputting a contents selection screen for selecting contents to be transmitted in voice communication and a motion pattern setting screen for informing transmission starting of the contents;
connecting the contents information and the motion pattern information selected and set through the outputted contents selection screen and motion pattern setting screen and storing them into the memory;
checking pattern information of motions sensed from at least one sensor disposed in the wireless terminal;
firstly checking whether the motion pattern information corresponding to the checked motion pattern information in the voice communication is pre-stored into the memory and secondly checking the contents information connected to the motion pattern information pre-stored into the memory; and transmitting the contents corresponding to the checked contents information to the other party's terminal.

9. The information processing method for the wireless terminal according to claim 8,
wherein the firstly checking checks whether the checked motion pattern information is corresponded to the motion pattern information pre-set by contents transmission commands in the voice communication.

10. The information processing method for the wireless terminal according to claim 8, wherein the contents is simultaneously driven at the wireless terminal and the other party' terminal on transmitting the contents corresponding to the checked contents information to the other party's terminal.

11. A computer-readable recording medium for recording programs to execute the method of claim 8.
